(19) United States
(12) Patent Application Publication
(10) Pub. No.: US 2005/0244091 A1
(43) Pub. Date: Nov. 3, 2005

(54) Gap-forming element for mounting on a shaft

(75) Inventors: Stephan Bross, Erpolzheim (DE); Ruediger Koepp, Ludwigshafen (DE)

Correspondence Address: CROWELL & MORING LLP;INTELLECTUAL PROPERTY GROUP, P.O. BOX 14300, WASHINGTON, DC, 20044-4300, US

(73) Assignee: KSB Aktiengesellschaft, Frankenthal (DE)

(21) Appl. No.: 11/106,484

(22) Filed: Apr. 15, 2005

Related U.S. Application Data
(63) Continuation of application No. PCT/EP03/09503, filed on Aug. 28, 2003.

(30) Foreign Application Priority Data
Oct. 16, 2002 (DE) 102 48 162.8

(51) Int. Cl. F16C 27/04

(52) U.S. Cl. 384/581

(57) ABSTRACT

An element which is to be mounted on a shaft of a non-positive displacement machine and which forms a gap for limited passage of a flowing medium, which includes a bush-like part (2) for mounting on a shaft of the machine having an outer periphery provided with a recess (4) for accommodating a ring (5). During operation of the machine, the ring (5), which is partially surrounded on its faces by circular ring-shaped walls of the recess (4), forms an axial gap with the circular, ring-shaped walls of the recess (4) and a radial gap with the bottom of the recess. Ring (5) is held by frictional contact with a rigid wall (1) which surrounds it. To reduce wear on rings made of soft, flowable material, a second recess is formed in the rigid wall (1) and surrounds the faces of the ring (5) that project from the walls of the bush-like part (2). One of the lateral bounds of the second recess is formed by a tubular part (7) detachably joined to the rigid wall (1).

### CROSS REFERENCE TO RELATED APPLICATIONS

This application is a continuation of international patent application no. PCT/EP2003/009503, filed Aug. 28, 2003, designating the United States of America, and published in German on Apr. 29, 2004 as WO 2004/036053, the entire disclosure of which is incorporated herein by reference. Priority is claimed based on Federal Republic of Germany patent application no. DE 102 48 162.8, filed Oct. 16, 2002.

### BACKGROUND OF THE INVENTION

The present invention relates to an element which is to be mounted on the shaft of a non-positive displacement machine and which forms a gap for limited passage of a flowing medium, having a bush-like part which is to be mounted on the shaft of the non-positive displacement machine and whose outer periphery has a recess for a ring, the ring which is partially surrounded at its end faces by circularly annular walls of the recess during operation of the non-positive displacement machine
a) forming an axial gap in each case with the circularly annular walls of the recess and forming a radial gap with the bottom of the recess,
b) being held via frictional contact by a rigid wall surrounding the ring.

Somewhat similar elements are disclosed in international patent application no. WO 02/12728 (=DE 100 38 586) and published US patent application no. US 2002/125649 (=DE 100 62 204). In these documents, the element has served as a relief piston in an axial thrust balancing device or as a sealing bush in a shaft seal. A common feature of both applications was that a slotted resilient ring was used which was widened slightly during operation of the non-positive displacement machine by the prevailing pressure, pressed against the housing inner wall and fixed in such a way.

The present invention, however, is not aimed only at elements with slotted rings, but is intended also to be suitable for application in closed rings. Independently of their design, rings made from a soft, flowable material result in the problem that their edge zones on the one side are pressed gradually into the gap between the piston or bush attached to the shaft and the surrounding housing hole by the pressure which acts on them. This results in increasing wear of the ring and the risk of the sealing action diminishing.

### SUMMARY OF THE INVENTION

It is an object of the invention to provide an improved element which is to be mounted on a shaft of a non-positive displacement machine and which forms a gap for limited passage of a flowing medium.

Another object of the invention is to provide a shaft-mounted, gap-forming element which minimizes wear.

A further object of the invention is to provide a shaft-mounted, gap-forming element which exhibits increased ring service life and thus also increases the service life of the gap-forming element.

These and other objects are achieved in accordance with the present invention by providing an element for mounting on a shaft of a non-positive displacement machine, said element forming a gap for limited passage of a flowing medium and comprising a bush part for mounting on the shaft of the machine, said bush part having an outer periphery provided with a first recess for accommodating a ring, said ring having end faces which are partially surrounded by circularly annular walls of said first recess, and said ring

a) forming an axial gap with the respective circularly annular walls of the recess and a radial gap with the bottom of the recess, and

b) being held by frictional contact with a rigid wall surrounding the ring,

wherein a second recess is formed in said rigid wall, said second recess enclosing the end faces of the ring which extend beyond the walls of said first recess in said bush part, and wherein said second recess is bounded laterally by a tubular part detachably joined to the rigid wall.

Thus, in accordance with the present invention, a recess is formed in the rigid wall surrounding the ring and surrounds the end faces of the ring that are free from the walls of the bush-like part, one of the lateral delimitations of the recess being formed by a tubular part detachably joined to the rigid wall.

As a result of the construction of the gap-forming element according to the invention, the ring is surrounded on all sides,and consequently no gap remains into which the ring could yield.

In order for it to be possible to move a closed ring into its position within the piston or the shaft-side bush, a delimitation ring which is detachably joined to the piston or the bush is arranged in that wall of the recess of said part which lies opposite the tubular part. It goes without saying that it is also possible in this way to mount a resilient ring which is separated by a longitudinally running gap. However, with less expenditure for the shaft-side bush-like part, this can also be widened and pushed over one of the lateral walls of the bush-like part.

A particular advantage of the invention is that the entire element, including the surrounding wall which in this case is likewise formed by a bush, can be assembled outside the non-positive displacement machine from separately manufactured parts to form a cartridge which is ready for installation.

The gap-forming element of the invention can be used advantageously as an axial thrust balancing device or as a shaft seal.

### BRIEF DESCRIPTION OF THE DRAWINGS

The invention will be described in further detail hereinafter with reference to illustrative preferred embodiments shown in the accompanying drawing figures in which:

FIG. 1 is a sectional view of a gap-forming element which has a resilient ring that is divided in the axial direction by a slot and which is configured as an installable cartridge; and

FIG. 2 is a sectional view of a cartridge which corresponds largely to FIG. 1, except that the gap-forming element has a closed ring.

### DETAILED DESCRIPTION OF PREFERRED EMBODIMENTS

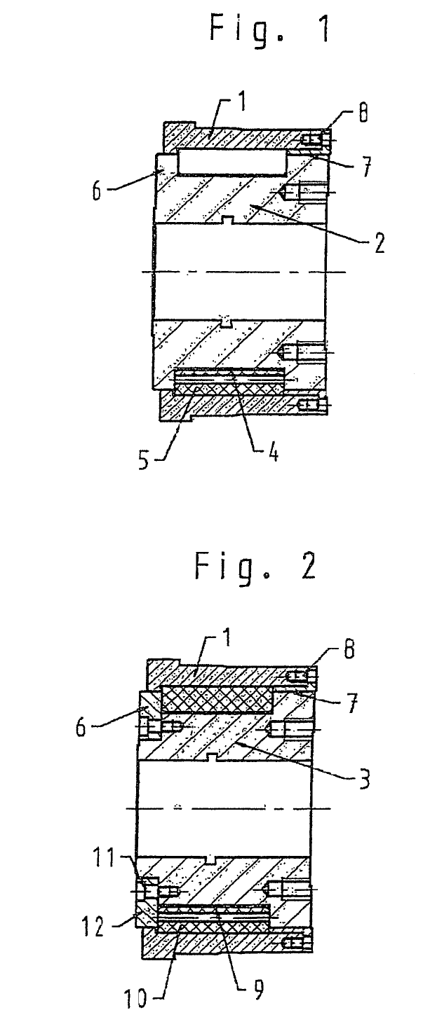

The pre-assembled units or cartridges which are shown in FIGS. 1 and 2 serve as relief pistons in axial thrust balancing devices. A common feature of both embodiments is a bush 1 which is to be mounted in a rotationally fixed and nondisplaceable manner in a centrifugal pump housing (not shown). The remaining parts of the elements are each inserted into the bush 1. A further bush-like part, namely a piston 2 or 3, is arranged on the shaft (not shown) of the centrifugal pump.

In the embodiment according to FIG. 1, the bush part or piston 2 has a recess 4 into which a piston ring 5 is inserted. The piston ring 5 is comprised of a resilient material and is divided by an axially extending slot (not shown). The resilience and the slot make it possible for the piston ring 5 to be expanded and pushed over the side wall 6 of the piston and to be secured in the recess 4. On the side of the cartridge which lies opposite the side wall 6 there is a tubular holding ring 7 which is inserted into the bush 1 after introduction of the piston 2 and the piston ring 5 and is fastened to the bush 1 by screws 8. Holding ring 7 has two effects: First, the holding ring 7 holds the cartridge together. Second, the holding ring 7 prevents the piston ring 5 from expanding into the region between the bush 1 and the push part or piston 2, as a result of which gradual wear is avoided in the region of an existing gap in the previously known configuration.

In the embodiment shown in FIG. 2, the bush part or piston 3 has a shoulder 9 onto which a closed piston ring 10 is pushed. In order to form a complete recess in which the piston ring is held, a bounding ring 12 which is fastened to the piston 3 by screws 11 is attached on the open side of the piston 3, that is to say, the side opposite from the holding ring 7. The holding ring 7 and the screws 8 correspond to those in the embodiment of FIG. 1.

A modification results if, instead of a cartridge which is ready for installation, a bush is used which is fastened in the housing of the non-positive displacement machine and is connected to the other parts of the element only in the housing. The invention is nevertheless also used in a embodiment of this type which appears less advantageous.

Although it serves a different purpose, the construction of an element for sealing a shaft is in principle the same as in the thrust balancing relief devices described above. However, the corresponding parts are denoted there by other designations than in the exemplary embodiments presented here.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. An element for mounting on a shaft of a non-positive displacement machine, said element forming a gap for limited passage of a flowing medium and comprising a bush part for mounting on the shaft of the machine, said bush part having an outer periphery provided with a first recess for accommodating a ring, said ring having end faces which are partially surrounded by circularly annular walls of said first recess, and said ring
a) forming an axial gap with the respective circularly annular walls of the recess and a radial gap with the bottom of the recess, and
b) being held by frictional contact with a rigid wall surrounding the ring,
wherein a second recess is formed in said rigid wall, said second recess enclosing the end faces of the ring which extend beyond the walls of the first recess in said bush part, and wherein said second recess is bounded laterally by a tubular part detachably joined to the rigid wall.

2. An element according to claim 1, wherein the lateral wall of said second recess opposite said tubular part is formed by a boundary ring which is detachably joined to the bush.

3. An element according to claim 2, wherein said ring is a rigid ring inserted with a frictional fit into said rigid wall which surrounds it.

4. An element according to claim 1, wherein the ring is a resilient ring which is separated by a longitudinally extending gap and which can be pushed over a lateral wall of the bush part by being expanded and can be secured in the recess of the bush part, and wherein the frictional contact between the ring and the rigid wall which surrounds it arises through expansion which occurs during operation of the non-positive displacement machine.

5. An element according to claim 1, wherein the rigid wall which surrounds the ring is formed by a bush which is fastened in a housing of the non-positive displacement machine in a rotationally fixed and nondisplaceable manner.

6. An element according to claim 1, wherein said element is constructed as a cartridge which is assembled outside the non-positive displacement machine and can be installed in the machine as a unit.

7. An element according to claim 1, wherein said element is an axial thrust balancing device.

8. An element according to claim 1, wherein said element is a shaft seal.
